(19) United States
(12) Patent Application Publication
(10) Pub. No.: US 2025/0333255 A1
(43) Pub. Date: Oct. 30, 2025

(54) LOADING SYSTEM FOR LOADING A TRANSPORT UNIT

(71) Applicant: Simec Systems Oy, Oitti (FI)

(72) Inventor: Simo AITTO-OJA, Oitti (FI)

(21) Appl. No.: 18/650,736

(22) Filed: Apr. 30, 2024

(51) Int. Cl. B65G 67/20; B65G 47/82; B65G 67/08

(52) U.S. Cl. CPC B65G 67/20; B65G 47/82; B65G 67/08

(57) ABSTRACT

The application relates to a loading system for loading a transport unit. The loading system comprises a chassis, a telescopic arm mounted on the chassis, and a loading carriage at a distal end of the telescopic arm. The telescopic arm is configured to extend in a loading direction (LD) and to telescope in a telescoping direction (TD) opposite the loading direction along the chassis. The loading system is configured to move the loading carriage with respect to the chassis in the loading and telescoping directions (LD, TD). The telescopic arm comprises telescopic profiles and each previous telescopic profile comprises rollers configured to project a next telescopic profile from the previous telescopic profile) in the loading direction and to telescope the next telescopic profile into the previous telescopic profile in the telescoping direction when each next telescopic profile comprises a roller rail mechanism for the rollers of the previous telescopic profile.

### TECHNICAL FIELD

The application relates generally to a loading system for loading a transport unit.

### BACKGROUND

Pallets are used to collect smaller goods or packages to larger palletized loads for transport. The pallets further support the loads during the transport so that damages to a transport unit and to the goods or packages are prevented. The pallets offer a standardized sized load and a sturdy support to handle and to transport the loads, which further minimizes loading and unloading time of transport units.

A transfer of palletized loads requires a durable and reliable loading device. Different kind of loading devices have been developed to transfer the palletized loads, but the palletized loads are typically loaded to transport units and unloaded from these transport units by means of a forklift or a pallet jack. The loading and unloading by means of these devices are however slow.

Transport units, e.g., containers of trucks, are closed spaces, which have limited room to move, whereupon only relatively small forklifts can be used in loading and unloading operations. Floors of the containers can further withstand only limited amounts of centralized point loads except where the floors are supported by a frame. This limits the combined weight of the loading forklift and palletized load that can be allowed.

Since it is advantageous to collect a load dimensioned for a transport unit in advance and move it as a single unit to the transport unit, a loading system according to patent application US 2023/0192425 has been developed to handle the palletized loads and to withdraw the previous drawbacks.

### SUMMARY

One object of the invention is to withdraw the drawbacks of known solutions and to provide a durable and reliable loading system, which comprises a light, dirt-resistant, and friction-reduced telescopic arm.

One object of the invention is fulfilled by providing the loading system, method, and computer-readable medium according to the independent claims.

Some embodiments of the invention are disclosed in the independent claims.

One loading system for loading a transport unit comprises a chassis, a telescopic arm mounted on the chassis, and a loading carriage at a distal end of the telescopic arm. The telescopic arm is configured to extend in a loading direction and to telescope in a telescoping direction opposite the loading direction along the chassis. The loading system is configured to move the loading carriage with respect to the chassis in the loading and telescoping directions. The telescopic arm comprises telescopic profiles and each previous telescopic profile comprises rollers configured to project a next telescopic profile from the previous telescopic profile in the loading direction and to telescope the next telescopic profile into the previous telescopic profile in the telescoping direction when each next telescopic profile comprises a roller rail mechanism for the rollers of the previous telescopic profile.

One loading method for loading a transport unit comprises a step of extending, by a controller, a telescopic arm mounted on a chassis in a loading direction along the chassis so that a loading carriage at a distal end of the telescopic arm moves with respect to the chassis in the loading direction. The loading method further comprises a step of telescoping, by the controller, the telescopic arm in a telescoping direction opposite the loading direction along the chassis so that the loading carriage moves with respect to the chassis in the telescoping direction. Rollers of each previous telescopic profile of the telescopic arm project a next telescopic profile from the previous telescopic profile of the telescopic arm, when the telescopic arm extends in the loading direction, and telescope the next telescopic profile into the previous telescopic profile, when the telescopic arm telescopes in the telescoping direction, by means of a roller rail mechanism of each next telescopic profile.

One tangible, non-transitory computer readable medium comprising a computer program that comprises instructions, which, when the computer program is executed by a controller comprising a processor, cause the controller to carry out at least the steps of the previous loading method.

### BRIEF DESCRIPTION OF THE FIGURES

The exemplary embodiments are explained with reference to the accompanying figures:

FIG. 1a presents a loading system with a controller and an extended telescopic arm

FIG. 1b presents the loading system with the telescoped telescopic arm

FIG. 1c presents details of a backside of the loading system with the telescoped telescopic arm

FIG. 1d presents the details of a frontside of the loading system with the telescoped telescopic arm

FIG. 2 presents a telescopic profile with rollers and an adjustment mechanism

FIG. 3 presents the structure of the telescoped arm from the backside

### DETAILED DESCRIPTION OF THE FIGURES

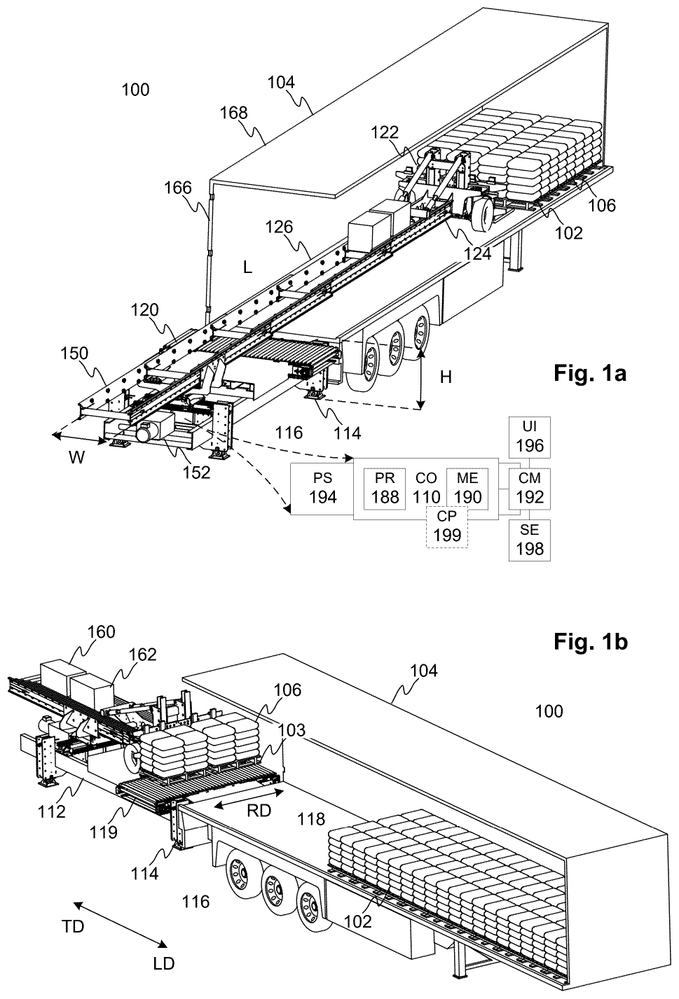

FIG. 1a-1d present a loading system 100 for loading a palletized load 102 into a transport unit 104 in a loading operation. The load 102 comprises at least one good 106, e.g., one, two, three, four, or more goods on each pallet 103.

The transport unit 104 comprises an unmodified cargo space, e.g., an open cargo space (transport platform) of a truck (not presented) or a trailer, closed cargo space (container) 104 of the truck according to the figure, closed cargo space of the trailer, or a freight container.

The loading system 100 comprises a controller 110 that is configured to control operating parts 120, 122, 152, 160, 162 of the loading system 100 to operate the loading system 100.

The loading system 100 further comprises a chassis 112 that is configured to establish a support structure, a mounting structure, and a protective structure for parts 120, 122, 152, 160, 162 of the loading system 100.

The chassis 112 may comprise legs 114 that are configured to mount the loading system 100 on a mounting platform (surface) 116 and to adapt a height H of the chassis 112 to match (level) the chassis 112 and a bottom surface (floor) 118 of the transportation unit 104 according to the figures. Each leg 114 comprises an adjustment actuator (not presented), e.g., a hydraulic actuator, that is configured to adjust the height H of the chassis 112 with respect to the mounting platform 116 and the bottom surface 118 in a vertical direction. The chassis 112 may not comprise the legs 114, whereupon it is alternatively configured be positioned directly on the mounting platform 116, which comprises a fixed loading platform (not presented).

The chassis 112 further comprises a ramp 117 mounted at a front side (end) of the chassis 112, which is in a loading direction LD. The ramp 1117 is configured to connect the chassis 112 and the bottom surface 118 of the transportation unit 104 so that the loading system 100 can transfer the palletized load 102 from the chassis 112, i.e., from a transverse transporter 119, to the transportation unit 104 in the loading operation and vice versa in an unloading operation. The ramp 117 comprises an adjustment actuator (not presented), e.g., a hydraulic actuator, that is configured to lower the ramp 117, i.e., to tilt the ramp 117 forwards FW, to connect the chassis 112 and the transportation unit 104 as well as to lift the ramp 117, i.e. to tilt the ramp 117 backwards BW, to disconnect the chassis 112 and the transportation unit 104.

The chassis 112 further comprises the transverse transporter 119, which is configured to transfer the palletized load 102 on the chassis 112 so that the loading system 100 is able to load the load 102 in a transverse direction RD perpendicular to loading and telescoping (unloading) directions LD, TD. The transverse transporter 119 is further configured to transfer the load 102 from the chassis 112 in the transverse direction RD, when the loading system 100 has unloaded the palletized load 102 on the transverse transporter 119.

The loading system 100 further comprises a telescopic arm (boom) 120 mounted on the chassis 112. The telescopic arm 120 comprises a loading carriage 122 at a distal (loading) end 124 of the telescopic arm 120.

The telescopic arm 120 is configured to extend in the loading direction LD so that its length L is about 10-16 m, e.g., 10, 12, 13, 14, or 16 m, and to telescope (retract) in a telescoping direction TD opposite the loading direction LD along the chassis 112 so that the loading carriage 122 at the distal end 124 is configured to move with respect to the chassis 112, i.e., on and along the chassis 112, in the loading and telescoping directions LD, TD by means of the telescopic arm 120.

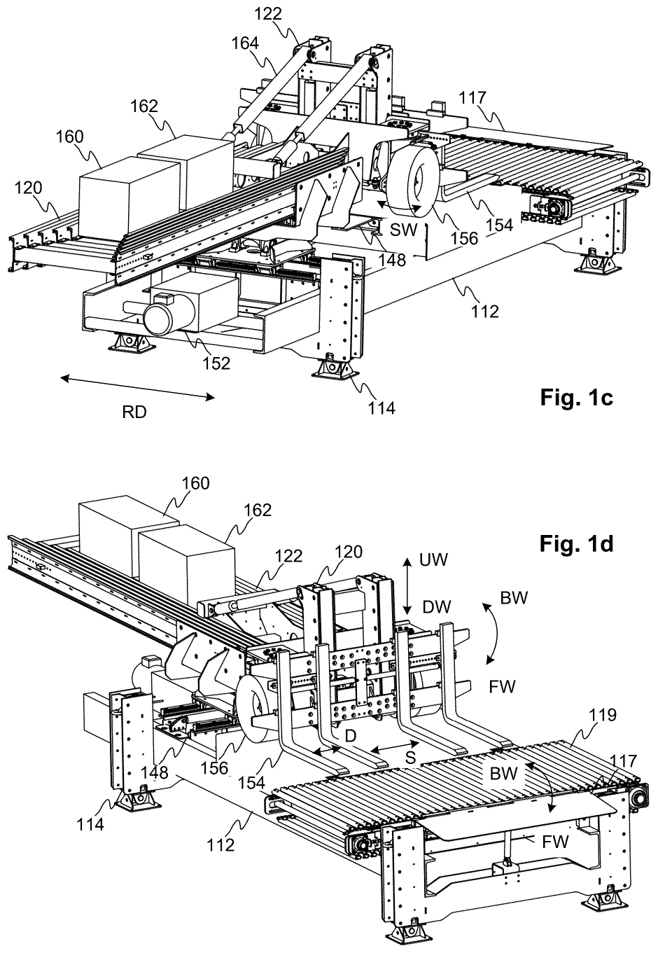

FIG. 2 presents how the telescopic arm 120 comprises telescopic profiles 226, which are configured to move with respect to each other except a first telescopic profile 226 at a proximal end 150 of the telescopic arm 120 so that the telescopic arm 120 extends in the loading direction LD and telescopes in the telescoping direction TD. A size, i.e., a width W, of the telescopic profiles 226 is configured to become narrower towards a last telescopic profile 226 at the distal end 124 of the telescopic arm 120 so that the telescopic profiles 226 can telescope according to the figures.

Each telescopic profile 226 comprises a substantially H or U shaped telescopic profile, which is made from elongated metallic, e.g., aluminium, steel, stainless steel, or titanium, structures (profiles) 234, 246.

Apart from the last telescopic profile 226 in the telescopic arm 120, each telescopic profile 226 further comprises rollers 230, which are configured to project each next telescopic profile 226 from the telescopic profile 226, which is a previous telescopic profile 226 compared to the next telescopic profile 226 in the loading direction LD. The rollers 230 are further configured to telescope the next telescopic profile 226 into the structure of the telescopic profile 226 in the telescoping direction TD when each telescopic profile 226 further comprises a rail mechanism (system) 232 for the rollers 230.

Each telescopic profile 226 comprises longitudinal structures 234, e.g., two longitudinal structures 234, which are configured to be substantially parallel with the loading and telescoping directions LD, TD so that inner flanks 236 of the longitudinal structures 234 are towards each other and outer flanks 238 of the longitudinal structures 234 are away from each other in the transverse direction RD. Each longitudinal structure 234 comprises a structure, which comprises a substantially U shaped cross section according to the figures or a substantially I shaped cross section. When the structure of longitudinal structures 234 comprises U shaped cross sections, the longitudinal structures 234 are configured to be installed in the telescopic profile 226 so that the U shaped longitudinal structures 234 are configured to open away from each other in outer flank directions, i.e., in the transverse direction RD, which are substantially perpendicular to the loading and telescoping directions LD, TD according to the figures.

Apart from the last telescopic profile 226 in the telescopic arm 120 as above has been explained, each longitudinal structure 234 in the telescope profile 226 comprises the rollers 230 with bearings in at least one roller line 240a, 240b on an inner flank 236 of the longitudinal structure 234 so that roller lines 240a, 240b of two longitudinal structures 234 are towards each other in the transverse direction RD in the telescopic profile 226. The at least one roller line 240a, 240b comprises, e.g., one or two roller lines 240a, 240b. When the telescopic profile comprises two roller lines 240a, 240b in each inner flank 236 of the longitudinal structures 234, the roller lines 240a, 240b comprises a lower roller line 240a and an upper roller line 240b according to the figures.

Apart from the last telescopic profile 226 in the telescopic arm 120 as above has been explained, each telescopic profile 226, i.e., each longitudinal structure 234, comprises an adjustment mechanism 242 for each roller 230 in the only roller line, when each longitudinal structure 234 comprises one roller line, and the adjustment mechanism 242 for each roller 230 in the lower or upper roller line 240a, 240b, when each longitudinal structure 234 comprises two roller lines 240a, 240b. Each adjustment mechanism 242 comprises an adjustment sleeve 241 attached on the inner flank 236 of the longitudinal structure 234, a wobbler (eccentric) shaft 231 in the roller 230, and an attachment screw 245 to attach the wobbler shaft 231 to a desired position with respect to the adjustment sleeve 241. The adjustment mechanism 242 is configured to adjust (change) the position, in fact a height H, of the roller 230 with respect to the longitudinal structure 234 so that the attachment of the wobbler shaft 231 and the roller 230 changes.

Each longitudinal structure 234 in the telescope profiles 226 comprises the rail mechanism 232 on its each outer flank 238 so that the rail mechanisms 232 are away from each other in the outer flank directions according to the figures. Each rail mechanism 232 is configured to slide by means of the rollers 230 of the previous telescope profile 226 so that the telescopic profile 226 projects from the previous telescopic profile 226 in the loading direction LD and telescopes into the structure of the previous telescopic profile 226 in the telescoping direction TD.

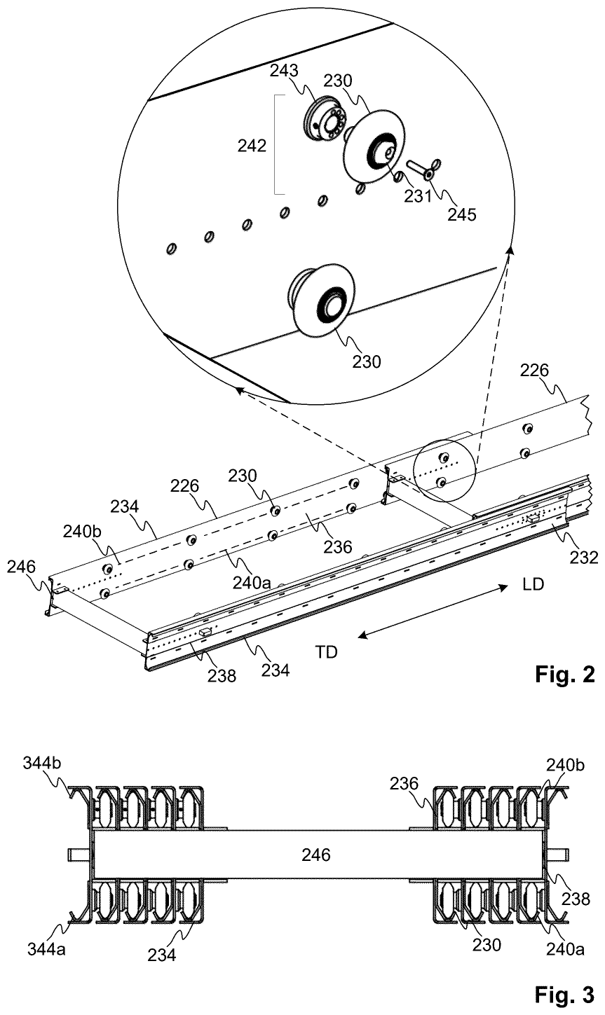

FIG. 3 presents the rail mechanism 232 and the rollers 230 in the telescoped telescopic arm 120 from the backside.

Each rail mechanism 232 in the telescopic profile 226 comprises a lower roller rail 344a to slide underneath at least part of the rollers 230, e.g., on all rollers 230 of the previous telescopic profile 226, when at least one roller line 240a, 240b comprises only one roller line, or underneath the rollers 230 of the lower roller line 240a of the previous telescopic profile 226, when at least one roller line 240a, 240b comprises two roller lines 240a, 240b.

Each rail mechanism 232 in the telescopic profile 226 further comprises an upper roller rail 344b to slide on at least part of the rollers 230, e.g., on all rollers 230 of the previous telescopic profile 226, when at least one roller line 240a, 240b comprises only one roller line, or on the rollers 230 of the upper roller line 240b of the previous telescopic profile 226, when at least one roller line 240a, 240b comprises two roller lines 240a, 240b.

The lower and upper roller rails 344a, 344b comprises, e.g., a substantially J shaped rails, which are made from elongated, bended metallic, e.g., aluminium, steel, stainless steel, or titanium, profiles. The lower and upper roller rails 344a, 344b have been bended so that the lower and upper roller rails 344a, 344b are configured to slide by means the rollers 230 in the loading and telescoping directions LD, TD. The lower and upper roller rails 344a, 344b of each telescopic profile 226 are further configured to reinforce the structure of the longitudinal structure 234, i.e., the structure of the telescopic profile 226, especially when the longitudinal structures 234 are U shaped.

The adjustment mechanisms 242 in the telescopic profiles 226 are configured to adjust the rollers 230 to remove unnecessary clearance between the rollers 230 and the lower or upper roller rails 344a, 344b of the next telescopic profiles 226 depending on the number of the roller lines 240a, 240b and which roller line 240a, 240b is adjustable in the case of two roller lines 240a, 240b so that the rollers 230 are configured to support the next telescopic profiles 226 and to allow the next telescopic profiles 226 to slide by means of the rollers 230.

FIG. 2 further presents how each telescopic profile 226 further comprises an elongated transverse structure 246, which is made from elongated, metallic, e.g., aluminium, steel, stainless steel, or titanium, profile. Each transverse structure 246 is configured to be installed between the longitudinal structures 234 substantially perpendicular to the loading and telescoping directions LD, TD according to the figures to connect the longitudinal structures 234 and to reinforce the structure of the telescopic profile 226.

FIG. 1a-1b further present how loading system 100 further comprises a telescopic frame 148 at the proximal end 150 of the telescopic arm 120. The telescopic frame 148 is configured to mount the telescopic arm 122 on the chassis 112 and to support the telescopic arm 120.

The chassis 112 further comprises an adjustment actuator 152, e.g., a hydraulic actuator, which is configured to adjust a position of the telescopic arm 120 with respect to the chassis 112 in the transverse direction RD perpendicular to the loading and telescoping directions LD, TD.

The loading carriage 122 at the distal end 124 of the telescopic arm 120 is mounted on the chassis 112 so that it is configured to rest on an upper part of the chassis 112 and to move along the chassis 112. The loading carriage 122 is configured to move with respect to the chassis 112, to carry the palletized load 102, to lift, lower, and tilt the load 102, and to drive the load 102 in the loading and telescoping directions LD, TD.

The loading carriage 122 comprises forklift forks 154, e.g., one or two pairs of the forklift forks 154, which are configured to move upwards UW with respect to other parts of the loading carriage 122 to lift the load 102 and to move downwards DW with respect to other parts of the loading carriage 122 to lower the load 102. The forklift forks 154 are further configured to tilt (incline) backwards BW and to tilt forwards FD by means of a tilting attachment (not presented) to enable the handling of the palletized load 102. The forklift forks 154 are further configured to move with respect to each other so that it is possible to adjust a distance D between forks 154 of the pair of the forklift forks as well as to adjust a distance S between the pairs of the forklift forks 154 if the loading carriage 122 comprises two pairs of the forklift forks 154 according to the figures.

The loading carriage 122 further comprises wheels 156, which are configured to move the loading carriage 122 in the loading and telescoping directions LD, TD with respect to the chassis 112. The wheels 156 are further configured to support the loading carriage 122 at least against the chassis 112, the transverse transporter 119, the ramp 117, and the bottom surface 118 of the transportation unit 104, when the loading carriage moves or stays on. The wheels 156 are further configured to turn sideways SW so that it is possible to move the loading carriage 122 on the chassis 112 also in the transverse directions RD with respect to the chassis 112.

The loading carriage 122 further comprises a power transmission system 160, e.g., an electric motor, to move the loading carriage 122 by means of the wheels 156 so that the telescopic arm 120 is configured to extend and to telescope and to move the loading carriage 122 by means of the wheels 156 so that the loading carriage 122 is configured to move in the transverse direction RD with respect to chassis 112.

The loading carriage 122 further comprises an adjustment system 162, which comprises adjustment actuators 164, e.g., hydraulic actuators. The adjustment actuators 164 comprise an adjustment actuator (not presented), e.g., a hydraulic actuator, configured to move the forklift forks 154 upwards UW and to move downwards DW with respect to other parts of the loading carriage 122 as well as an adjustment actuator 164, e.g., hydraulic actuator, configured to tilt the forklift forks 154 backwards BW and forwards FW with respect to other parts of the loading carriage 122. The adjustment actuators 164 further comprise an adjustment actuator (not presented), e.g., a hydraulic actuator, configured to adjust the distance D between forks 154 of the pair of the forklift forks 154 and the distance S between the pairs of the forklift forks 154.

The loading carriage 122 further comprises at least one sensor 198, e.g., one, two, three, four, or more sensors, to sense side walls 166 and roof 168 of the transport unit 104 so that the loading carriage 122 is possible to move autonomously inside the transport unit 104 without crashing into the side walls 166 or roof 168 of the transport unit 104.

Each adjustment actuator 152, 164 in the loading system 100, which comprises the adjustment actuators, comprises a hydraulic cylinder, electric belt-driven actuator, rack and pinion-driven actuator, gearwheel-driven actuator, electric cylinder, or pneumatic cylinder.

The loading method for loading the transport unit 104 is carried by the previously explained loading system 100, which has been explained previously and later on.

At a first step, when the transportation unit 104, e.g., the closed cargo space, has been driven by the truck in front of the loading system 100 so that it is possible to load the transportation unit 104 and rear doors of the transportation unit 104 have been opened, the telescopic arm 120 and the loading carriage 122 at its distal end 124 are in a home position according to FIGS. 1c and 1d.

The controller 110 causes the ramp 117 to tilt backward BW by means of the adjustment actuator, e.g., hydraulic actuator, if necessary. The controller 110 further causes the loading system 100 to match the height H of the chassis 112 to the bottom surface 118 of the transportation unit 104 by means of the adjustment actuators of the legs 114 and at least one sensor 198, if necessary

At a second step, the palletized load(s) 102 is arranged, e.g., by means of a forklift truck, on the transverse transporter 119 and the controller 110 causes the transverse transporter 119 to transfer the load(s) 102 in front of an open backside of the transportation unit 104.

At a third step, when the loading carriage 122 is near the transverse transporter 119 and the load(s) 102 in the home position, the controller 110 causes the loading carriage 122 to tilt the forklift forks 154 backwards BW or forwards FW by means of the adjustment actuator 164, e.g., hydraulic actuator, if necessary, and to move the forklift forks 154 upwards UW or downwards DW by means of the adjustment actuator, e.g., hydraulic actuator, if necessary, to arrange the forklift forks 154 so that the forklift forks 154 are appropriately positioned. The controller 110 further causes the loading carriage 122 to adjust the distance D, the distance S, or both in the forklift forks 154 by means of the adjustment actuator, e.g., hydraulic actuator, so that the forklift forks 154 fit to gaps of the pallet(s) 103 underneath the good(s) 106, if necessary. The controller 110 further causes the adjustment actuator 152, e.g., a hydraulic actuator, to adjust the position of the telescopic frame 148, i.e., the first telescopic profile 226, in the transverse direction RD and the loading carriage 122 to turn the wheels 156 in the sideways SW, if necessary.

At a fourth step, when the forklift forks 154 and the telescopic arm 122 are appropriately positioned, the controller 110 causes the loading carriage 122 to move in the loading direction LD so that the telescopic arm 120 extends by means of the power transmission 160, e.g. the electric motor, and the wheels 156. The movement of the loading carriage 122 in the loading direction LD causes each next telescopic profile 226 to slide by means of its rail mechanism 232 and the rollers 130 of the previous telescopic profile 226 out from the structure of the previous telescopic profile 226. As a result of the movement, the forklift forks 154 push to the gaps of the pallet(s) 103. The controller 110 then causes the loading carriage 122 to lift the forklift forks 154 upwards UW and to tilt backwards BW so that the loading carriage 122 carries the load(s) 102.

At a fifth step, the controller 110 causes the loading carriage 122 to move in the loading direction LD so that the telescopic arm 120 extends by means of the power transmission 160, the wheels 156, and sensors 198 over the ramp 117 into the interior of the transportation unit 104, wherein the controller 110 causes the loading carriage 122 to stop its movement when the load 102 above an appropriate position in the transportation unit 104. The controller 110 further causes the adjustment actuator 152 to adjust the position of the telescopic frame 148 in the transverse direction RD and the loading carriage 122 to turn the wheels 156 to drive the loading carriage 122 in the sideways SW during the extension operation, if necessary when reaching the appropriate position.

At a sixth step, the controller 110 causes the loading carriage 122 to lower the forklift forks 154 underneath the load(s) 102 downwards DW by means of the adjustment actuator and to tilt forwards FW by means of the adjustment actuator 164 so that the load(s) 102 are supported only by the bottom surface 118 of the transportation unit 104, not even partly by the loading carriage 122 anymore.

At a final seventh step, when the load(s) 102 are positioned in the transportation unit 104, the controller 110 causes the loading system 100 to telescope the telescopic arm 120 in the telescoping direction TD to the home position by means of the power transmission 160 and the wheels 156. The movement of the loading carriage 122 in the telescoping direction TD causes each next telescopic profile 226 to slide by means of its rail mechanism 232 and the rollers 130 of the previous telescopic profile 226 back into the structure of the previous telescopic profile 226. After the telescoping operation the loading system 100 is ready to load a next palletized load(s) 102 in the transport unit 104 or an unloading operation.

The controller 110 is configured to receive information from the operating parts 120, 122, 152, 160, 162 and to control an operation of the operating parts 120, 122, 152, 160, 162, e.g., one, four, eight, twelve, or more operating parts, and the actuators 164 on grounds of the received information, e.g., the sensed information from the loading system 100.

The controller 110 comprises a processor 188 to carry out operator-initiated instructions, computer program (application, software)-initiated instructions, or both, and to process data to run computer programs. The processor 188 comprises at least one processor, e.g., one, two, three, four, or more processors.

The controller 110 further comprises a memory 190 to store and to maintain information. The information comprises, e.g., instructions, computer programs, and in-formation files. The memory 190 comprises at least one memory, e.g., one, two, three, four, or more memories.

The loading system 100 further comprises a communicator 192 that the controller 110 is configured to control to send commands to at least one of, e.g., the operating part(s) 120, 122, 152, 160, 162 in the loading system 100. The controller 110 is further configured to control the communicator 192 to receive information from at least one of, e.g., the operating parts 120, 122, 152, 160, 162 or the sensors 198. The communication between the communicator 192 and at least one of the operating parts 120, 122, 152, 160, 162 and sensors 198 in the loading system 100 is carried out through a wired connection(s), wireless connection(s), or both connections.

The loading system 100 further comprises a power supplier 194 that the controller 110 is configured to control to power the operation of the loading system 100. The power supplier 194 comprises at least one supplier part to power the loading system 100, e.g., a connection to an external power source, e.g., to a power network or other power source, at least one battery, e.g., one, two, three, four, or more batteries, regulator, or other supplier part.

The loading system 100 further comprises a user interface 196 that the controller 110 is configured to control to receive instructions, requests, or information, e.g., from the operator or other entity. The controller 110 is further configured to control the user interface 196 to present instructions, requests, or information, e.g., to the operator or other entity.

The loading system 100 further comprises the sensors 198 that are configured to sense necessary information at least in the adaptation of the height H of the chassis 112 to match the chassis 112 and the bottom surface 118 of the transportation unit 104 and in the control of loading carriage 122 as well as other necessary information so that the controller 110 is configured to control the operation of the loading system 100.

The memory 190 is configured to store at least a communicator program to operate (control) the communicator 192, a power supplier program to operate the power supplier 194, and a user interface program to operate the user interface 196. The memory 190 is further configured to store a computer program 199 that the controller 110 is configured to execute (run, carry out) to control the operation of the loading system 100 as previously has been explained. The computer program 199 comprises computer readable code instructions.

The computer program 199 may be stored in a tangible, non-transitory computer-readable medium, e.g., a Compact Disc (CD) or Universal Serial Bus (USB) storage device.

The invention has been now explained above with reference to the aforesaid exemplary embodiments and the several advantages of the invention have been demonstrated. It is clear that the invention is not only restricted to these embodiments but comprises all possible embodiments within the scope of the following claims.

1. A loading system for loading a transport unit, comprising a chassis,
a telescopic arm mounted on the chassis, and
a loading carriage at a distal end of the telescopic arm,
which telescopic arm is configured to extend in a loading direction (LD) and to telescope in a telescoping direction (TD) opposite the loading direction along the chassis and
which loading system is configured to move the loading carriage with respect to the chassis in the loading and telescoping directions (LD, TD),
wherein the telescopic arm comprises telescopic profiles and each previous telescopic profile comprises rollers configured to project a next telescopic profile from the previous telescopic profile in the loading direction and to telescope the next telescopic profile into the previous telescopic profile in the telescoping direction when each next telescopic profile comprises a roller rail mechanism for the rollers of the previous telescopic profile.

2. The loading system according to claim 1, wherein each telescopic profile comprises a H or U shaped telescopic profile, which comprises longitudinal structures substantially parallel with the loading and telescoping directions (LD, TD) and a transverse structure, which is substantially perpendicular to the loading and telescoping directions, between the longitudinal structures.

3. The loading system according to claim 2, wherein the longitudinal structures comprise U shaped structures, which are configured to open away from each other in each telescopic profile.

4. The loading system according to claim 3, wherein each longitudinal structure in the previous telescope profile comprises at least one roller line, which comprises the rollers with bearings, on an inner flank of a U shaped structure so that roller lines are towards each other in the previous telescopic profile.

5. The loading system according to claim 4, wherein the at least one roller line comprises a lower roller line and an upper roller line on the inner flank of each longitudinal structure.

6. The loading system according to claim 5, wherein each previous telescopic profile comprises an adjustment mechanism for each roller in one of the at least one roller line, which is configured to adjust a position (H) of the roller with respect to the longitudinal structure.

7. The loading system according to claim 1, wherein each roller rail mechanism in the next telescope profile comprises a lower roller rail and an upper roller rail to slide by means of the rollers of the previous telescope profile and to reinforce the longitudinal structure.

8. The loading system according to claim 7, wherein the lower roller rail is configured to slide underneath the rollers of a lower roller line (240a) of the previous telescope profile and the upper roller rail is configured to slide on the rollers of an upper roller line (240b) of the previous telescope profile.

9. The loading system according to claim 1, wherein a width (W) of each next telescopic profile in a transverse direction (RD) perpendicular to the loading and telescoping directions is smaller than a width (W) of the previous telescopic profile.

10. The loading system according to claim 1, wherein the loading carriage comprises a power transmission and wheels to move the loading carriage with respect to the chassis.

11. The loading system according to claim 1, wherein the loading carriage comprises forklift forks configured to move upwards (UW) with respect to the loading carriage to lift a load and to move downwards (DW) with respect to the loading carriage to lower the load.

12. The loading system according to claim 1, wherein the chassis comprises legs configured to mount the loading system on a mounting platform and each leg comprises an adjustment actuator configured to adjust a height (H) of the chassis with respect to the mounting platform.

13. The loading system according to claim 1, wherein the chassis comprises a telescopic frame configured to support the telescopic arm and an adjustment actuator configured to adjust a position (P) of the telescopic frame in a transverse direction (RD) perpendicular to the loading and telescoping directions with respect to the chassis.

14. The loading system according to claim 1, which comprises a controller configured to control at least one actuator and a power transmission to operate the loading system.

15. A loading method for loading a transport unit, comprising at least steps of extending, by a controller, a telescopic arm mounted on a chassis in a loading direction (LD) along the chassis so that a loading carriage at a distal end of the telescopic arm moves with respect to the chassis in the loading direction and
telescoping, by the controller, the telescopic arm in a telescoping direction (TD) opposite the loading direction along the chassis so that the loading carriage moves with respect to the chassis in the telescoping direction,
wherein rollers of each previous telescopic profile of the telescopic arm project a next telescopic profile from the previous telescopic profile of the telescopic arm, when the telescopic arm extends in the loading direction, and telescope the next telescopic profile into the previous telescopic profile, when the telescopic arm telescopes in the telescoping direction, by means of a roller rail mechanism of each next telescopic profile.

16. A tangible, non-transitory computer readable medium comprising a computer program that comprises instructions, which, when the computer program is executed by a controller comprising a processor, cause the controller to carry out at least the steps of the loading method according to claim 15.
